(19) United States
(12) Patent Application Publication
(10) Pub. No.: US 2008/0230444 A1
(43) Pub. Date: Sep. 25, 2008

(54) Hydrocarbon Material Processing System and Method

(76) Inventors: Yuki Iwadate, Tokyo (JP); Takao Kobayashi, Tokyo (JP); Seiichiro Toyoda, Tokyo (JP); Takashi Imaizumi, Tokyo (JP); Fumiaki Morozumi, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/586,439

(22) PCT Filed: Jan. 27, 2005
(86) PCT No.: PCT/JP2005/001552

§ 371 Date: Jul. 18, 2006

(30) Foreign Application Priority Data
Feb. 3, 2004 (JP) 2004-027052

(51) Int. Cl. C10G 9/00; B01J 19/00

(52) U.S. Cl. 208/128; 422/198

(57) ABSTRACT

A hydrocarbon material processing system can reduce consumption of fossil fuel, environmental loads, and cost for processing a hydrocarbon material. The hydrocarbon material processing system has a gasification furnace (10) for pyrolyzing and gasifying wastes (51), waste plastics (52), pyrolysis tar (53), residual hydrocarbon heavy oil (54), and organic matter such as biomass (55) to produce a heat source gas. The hydrocarbon material processing system also has a cracking furnace (101) for thermally cracking a hydrocarbon material by using the heat source gas produced in the gasification furnace (10).

### TECHNICAL FIELD

The present invention relates to a hydrocarbon material processing system and method, and more particularly to a hydrocarbon material processing system and method used in an oil refinery process or a petrochemical process for thermally cracking a hydrocarbon material in a cracking furnace or for reforming a hydrocarbon material in a reforming furnace.

### BACKGROUND ART

Ethylene is used as raw materials of various manufactured products, such as polyethylene, polypropylene, or ethyl acetate, and is thus one of the most fundamental materials in a chemical industry. Ethylene is produced by pyrolyzing and refining a hydrocarbon material such as naphtha. Further, propylene, ethane, propane, and the like, which are produced in the pyrolysis of the hydrocarbon, are also used as industrial raw materials.

In an oil refinery process, a large amount of hydrogen is required as a desulfurizing agent or an alkylation agent. In Japan, hydrogen is mostly produced by steam reforming of hydrocarbon such as naphtha or liquefied petroleum gas (LPG). If a manufacturing process of gasoline, light oil, or the like requires a higher level of desulfurization to reduce environmental loads such as SOx, then a larger amount of hydrogen is required for desulfurization. As a result, a large amount of fossil fuel is consumed.

### Manufacturing Process of Ethylene

FIG. 1 is a block diagram illustrating a system for manufacturing ethylene. As shown in FIG. 1, the ethylene manufacturing system includes a cracking furnace 101, a heat exchanger 102, an oil quenching tower 103, a water quenching tower 104, a compressor 105, an acid gas removal unit 106, a dehydrating tower 107, and a gas separation and refining unit 108. Steam is added to naphtha for dilution to produce a raw material 201. The raw material 201 is supplied into reaction pipes 101a in the cracking furnace 101, where the raw material 201 is preheated for evaporation and then pyrolyzed at a high temperature under a low pressure for a short residence time. In order to prevent excessive pyrolysis, the heat exchanger 102 for quickly cooling the produced gas is provided downstream of outlets of the reaction pipes 101a. The produced gas is further cooled in the oil quenching tower 103 and the water quenching tower 104, and thus heat is recovered from the produced gas.

The cooled gas is pressurized up to an atmospheric pressure of about 0.5 to 30 by the multistage compressor 105. Then, an acid gas such as H₂S or CO₂ is removed from the cooled gas in the acid gas removal unit 106, and the cooled gas is dehydrated in the dehydrating tower 107. Thereafter, the cooled gas is introduced into the gas separation and refining unit 108 to separate unnecessary components of the gas. As a result, ethylene 202 is obtained as a product.

As shown in FIG. 1, the gas separation and refining unit 108 includes a demethanator 109, a deethanizer 110, a depropanizer 111, a methyl acetylene/propadiene hydrogenation unit 112, an ethylene rectifying tower 113, a propylene rectifying tower 114, a cold box 115, and an acetylene hydrogenation unit 116. The gas separation and refining unit 108 separates hydrogen-rich gas 203, tail gas 204, propylene 205, hydrocarbon having at least four carbons (C4+) 206, ethane 207, propane 208, off-gas 209, and the like. The gas separation and refining unit 108 is shown in FIG. 1 by way of example and may have other arrangements.

The cracking furnace 101 has a plurality of reaction pipes 101a. The cracking furnace 101 decomposes C—C bonds of hydrocarbon without any catalysts at a high temperature of about 800 to 900° C. under a low pressure of about 0.2 MPa to produce a lower hydrocarbon. The residence time of naphtha as a raw material in the reaction pipes 101a is considerably short and is not longer than about 0.1 to 0.2 second. The cracking furnace 101 has a burner (not shown) disposed in a furnace outside of the reaction pipes 101a. The off-gas 209 from the gas separation and refining unit 108 is combusted as fuel with air 210 to increase and maintain the temperature of the cracking furnace 101. Ethane 207 and propane 208 may also be used as fuel in the cracking furnace 101. Further, when a sufficient amount of heat is not obtained from the off-gas. 209, ethane 207, and propane 208 to maintain the temperature of the cracking furnace 101, fossil fuel such as naphtha 211 is used as fuel in the cracking furnace 101.

Air 210 for combustion is preheated by sensible heat of exhaust gas 212 discharged from the cracking furnace 101. The amounts of off-gas 209, ethane 207, propane 208, and fossil fuel such as naphtha 211 to be supplied to the cracking furnace 101 are adjusted to maintain the temperature of gas in the reaction pipes 101a at a constant value. Hydrocarbon of the raw material 201, such as naphtha, is preheated by the sensible heat of the exhaust gas from the cracking furnace 101 and then supplied to the reaction pipes 101a of the cracking furnace 101. The heat exchanger 102 (e.g., boiler) is provided downstream of the reaction pipes 101a to quickly cool the gas so as to inhibit the reaction. Thus, the heat exchanger 102 prevents a yield of a product (i.e., ethylene 202) from being lowered due to excessive pyrolysis.

### Manufacturing Process of Hydrogen

There have been known three methods of producing hydrogen, which include a steam reforming method, a partial oxidation method, and a combination of the steam reforming method and the partial oxidation method. Recently, there has been widely employed a method of reforming hydrocarbon, such as naphtha or LPG, with steam to produce hydrogen. In this method, catalytic reaction occurs between hydrocarbon and steam on a catalyst at temperatures of about 800 to 850° C. This method employs the following endothermic reaction.

CₙHₘ+nH₂O⇄nCO+(n+m/2)H₂ (endothermic reaction)

Produced carbon monoxide is converted into hydrogen by the following water-gas shift reaction.

CO+H₂O⇄CO₂+H₂ (exothermic reaction)

Each of the above two reactions requires a catalyst such as a catalyst carried with nickel.

FIG. 2 is a block diagram illustrating a system for manufacturing hydrogen, which employs a steam reforming method. In the hydrogen manufacturing system, hydrocarbon such as naphtha or LPG is used as a raw material 231. As shown in FIG. 2, the hydrogen manufacturing system includes a desulfurizer 131 for desulfurizing the raw material 231, a preliminary reforming unit 132 and a reforming furnace 133 for reforming the desulfurized raw material 231 with steam, a heat exchanger 134, a shift converter 135 for converting the produced carbon monoxide into hydrogen by the water-gas shift reaction, a heat exchanger 136, a separator 137 for separating hydrogen, and a hydrogen pressure swing adsorption (hydrogen PSA) unit 138.

A raw material, which is liquid under an ordinary temperature, is heated and evaporated. The evaporated raw material is supplied to the reforming furnace 133. Waste heat of exhaust gas 236 discharged from the reforming furnace 133 may be used to heat the raw material. Since the steam reforming reaction of the raw material occurs on a catalyst, it is necessary to remove sulfur, which is a poisoning component. When the raw material contains a large amount of sulfur, the evaporated raw material is desulfurized by the desulfurizer 131. The raw material gas is supplied together with steam into a reforming reaction pipe 133a in the reforming furnace 133. The reforming reaction pipe 133a is filled with a catalyst. Generally, a catalyst carried with nickel is used as a catalyst in the reforming reaction pipe 133a. The raw material gas may preliminarily be reformed in the preliminary reforming unit 132 disposed upstream of the reforming reaction pipe 133a. The raw material gas has temperatures of about 450 to 650° C. at an inlet of the reforming reaction pipe 133a and about 700 to 950° C. at an outlet of the reforming reaction pipe 133a. Specifically, heat is supplied from an external heat source to the reforming reaction pipe 133a in the reforming furnace 133 so that the reforming reaction occurs within a temperature range of about 600 to 950° C.

The heat source for the reforming furnace 133 is combustion heat of off-gas 232 discharged from the hydrogen refining process (hydrogen PSA unit 138) or hydrocarbon fuel 233 such as naphtha or LPG with air 234. The produced carbon monoxide is cooled by heat exchange in the heat exchanger 134 disposed downstream of the reforming reaction pipe 133a in the reforming furnace 133. Then, the produced carbon monoxide is converted into hydrogen by the water-gas shift reaction in the shift converter 135. The produced hydrogen passes through the heat exchanger 136. The separator 137 separates a condensate 237. In the hydrogen PSA unit 138, hydrogen 230 is separated from off-gas 232 and thus recovered. The off-gas 232 from which hydrogen 230 is separated is employed as the heat source for the reforming furnace 133, as described above. A portion of hydrogen 230 may be mixed as recycled hydrogen 235 with the raw material 231 to increase the concentration of hydrogen in the raw material 231.

As described above, the conventional ethylene manufacturing system and hydrogen manufacturing system consume a large amount of fossil fuel, such as naphtha or LPG, as heat sources for a cracking furnace and a reforming furnace, thereby increasing cost of manufacturing ethylene and hydrogen.

### DISCLOSURE OF INVENTION

The present invention has been made in view of the above drawbacks. It is, therefore, a first object of the present invention to provide a hydrocarbon material processing system which can reduce consumption of fossil fuel, environmental loads, and cost for processing a hydrocarbon material.

A second object of the present invention is to provide a hydrocarbon material processing method which can reduce consumption of fossil fuel, environmental loads, and cost for processing a hydrocarbon material.

According to a first aspect of the present invention, there is provided a hydrocarbon material processing system capable of reducing consumption of fossil fuel, environmental loads, and cost for processing a hydrocarbon material. The hydrocarbon material processing system has a gasification furnace for pyrolyzing and gasifying at least one of wastes, residual hydrocarbon heavy oil, and organic matter to produce a heat source gas. The hydrocarbon material processing system also has a cracking furnace for thermally cracking a hydrocarbon material by using the heat source gas produced in the gasification furnace. Specifically, the hydrocarbon material processing system employs a combustible gas as a heat source for a cracking furnace to thermally crack a hydrocarbon material in an ethylene manufacturing system or the like. The combustible gas is produced by pyrolysis and gasification of at least one of various wastes, residual hydrocarbon heavy oil such as heavy oil discharged from an oil refinery process or a petrochemical process, and organic matter such as biomass. The cracking furnace may comprise a cracking furnace for an ethylene manufacturing process.

Thus, a heat source gas is produced by pyrolysis and gasification of at least one of wastes, residual hydrocarbon heavy oil, and organic matter. The heat source gas is used as a heat source for a cracking furnace to thermally crack a hydrocarbon material. Accordingly, it is possible to reduce consumption of fossil fuel, environmental loads, and cost for processing a hydrocarbon material.

The gasification furnace may be configured to separately produce a first gas by pyrolysis and gasification of at least one of wastes, residual hydrocarbon heavy oil, and organic matter and a second gas by combustion of a residue of the pyrolysis and gasification. The first gas (produced gas), which is produced by pyrolysis and gasification, can be obtained without being mixed (diluted) with the second gas (combustion gas), which is produced by combustion of a residue of the pyrolysis and gasification. Accordingly, a high heating value can be achieved even from a small amount of the first gas to thereby maintain the cracking furnace at a high temperature. Further, since the cracking furnace can be maintained at a high temperature, the cracking furnace can perform combustion even if the first gas contains impurities.

Since the second gas contains oxygen, the second gas can be used as the heat source gas for the cracking furnace. Accordingly, it is possible to reduce the amount of combustion air to be supplied to the cracking furnace. Further, the sensible heat of the second gas can effectively be utilized. Thus, it is possible to more effectively reduce consumption of fossil fuel, environmental loads, and cost for processing a hydrocarbon material.

The hydrocarbon material processing system may include a heat exchanger for preheating air by the second gas and a passage for supplying the preheated air to the cracking furnace. In this case, since the second gas is used for preheating air, the heat of the second gas can effectively be utilized. Thus, it is possible to more effectively reduce consumption of fossil fuel, environmental loads, and cost for processing a hydrocarbon material.

According to a second aspect of the present invention, there is provided a hydrocarbon material processing system capable of reducing consumption of fossil fuel, environmental loads, and cost for processing a hydrocarbon material. The hydrocarbon material processing system has a gasification furnace for pyrolyzing and gasifying at least one of wastes, residual hydrocarbon heavy oil, and organic matter to produce a heat source gas. The hydrocarbon material processing system also has a reforming furnace for reforming a hydrocarbon material by using the heat source gas produced in the gasification furnace. Specifically, the hydrocarbon material processing system employs a combustible gas as a heat source for a reforming furnace to reform a hydrocarbon material in a hydrogen manufacturing system or the like. The combustible gas is produced by pyrolysis and gasification of at least one of various wastes, residual hydrocarbon heavy oil such as heavy oil discharged from an oil refinery process or a petrochemical process, and organic matter such as biomass. The reforming furnace may comprise a reforming furnace for a hydrogen manufacturing process.

Thus, a heat source gas is produced by pyrolysis and gasification of at least one of wastes, residual hydrocarbon heavy oil, and organic matter. The heat source gas is used as a heat source for a reforming furnace to reform a hydrocarbon material. Accordingly, it is possible to reduce consumption of fossil fuel, environmental loads, and cost for processing a hydrocarbon material.

The gasification furnace may be configured to separately produce a first gas by pyrolysis and gasification of at least one of wastes, residual hydrocarbon heavy oil, and organic matter and a second gas by combustion of a residue of the pyrolysis and gasification. The first gas (produced gas), which is produced by pyrolysis and gasification, can be obtained without being mixed (diluted) with the second gas (combustion gas), which is produced by combustion of a residue of the pyrolysis and gasification. Accordingly, a high heating value can be achieved even from a small amount of the first gas to thereby maintain the reforming furnace at a high temperature. Further, since the reforming furnace can be maintained at a high temperature, the reforming furnace can perform combustion even if the first gas contains impurities.

Since the second gas contains oxygen, the second gas can be used as the heat source gas for the reforming furnace. Accordingly, it is possible to reduce the amount of combustion air to be supplied to the reforming furnace. Further, the sensible heat of the second gas can effectively be utilized. Thus, it is possible to more effectively reduce consumption of fossil fuel, environmental loads, and cost for processing a hydrocarbon material.

The hydrocarbon material processing system may include a heat exchanger for preheating air by the second gas and a passage for supplying the preheated air to the reforming furnace. In this case, since the second gas is used for preheating air, the heat of the second gas can effectively be utilized. Thus, it is possible to more effectively reduce consumption of fossil fuel, environmental loads, and cost for processing a hydrocarbon material.

According to a third aspect of the present invention, there is provided a hydrocarbon material processing method capable of reducing consumption of fossil fuel, environmental loads, and cost for processing a hydrocarbon material. According to the hydrocarbon material processing method, at least one of wastes, residual hydrocarbon heavy oil, and organic matter is pyrolyzed and gasified to produce a heat source gas. The heat source gas is supplied to a cracking furnace for thermally cracking a hydrocarbon material. Specifically, the hydrocarbon material processing method employs a combustible gas as a heat source for a cracking furnace to thermally crack a hydrocarbon material in an ethylene manufacturing system or the like. The combustible gas is produced by pyrolysis and gasification of at least one of various wastes, residual hydrocarbon heavy oil such as heavy oil discharged from an oil refinery process or a petrochemical process, and organic matter such as biomass. The cracking furnace may comprise a cracking furnace for an ethylene manufacturing process.

According to a fourth aspect of the present invention, there is provided a hydrocarbon material processing method capable of reducing consumption of fossil fuel, environmental loads, and cost for processing a hydrocarbon material. According to the hydrocarbon material processing method, at least one of wastes, residual hydrocarbon heavy oil, and organic matter is pyrolyzed and gasified to produce a heat source gas. The heat source gas is supplied to a reforming furnace for reforming a hydrocarbon material. Specifically, the hydrocarbon material processing method employs a combustible gas as a heat source for a reforming furnace to reform a hydrocarbon material in a hydrogen manufacturing system or the like. The combustible gas is produced by pyrolysis and gasification of at least one of various wastes, residual hydrocarbon heavy oil such as heavy oil discharged from an oil refinery process or a petrochemical process, and organic matter such as biomass. The reforming furnace may comprise a reforming furnace for a hydrogen manufacturing process.

The above and other objects, features, and advantages of the present invention will be apparent from the following description when taken in conjunction with the accompanying drawings which illustrate preferred embodiments of the present invention by way of example.

### BRIEF DESCRIPTION OF DRAWINGS

FIG. 1 is a block diagram illustrating an ethylene manufacturing system;

FIG. 2 is a block diagram illustrating a hydrogen manufacturing system;

FIG. 3 is a block diagram illustrating a hydrocarbon material processing system according to a first embodiment of the present invention;

FIG. 4 is a cross-sectional view showing an example of an internal circulating fluidized-bed gasification furnace which can be used as a gasification furnace in the hydrocarbon material processing system shown in FIG. 3;

FIG. 5 is a block diagram illustrating a hydrocarbon material processing system according to a second embodiment of the present invention;

FIG. 6 is a block diagram illustrating a hydrocarbon material processing system according to a third embodiment of the present invention;

FIG. 7 is a block diagram illustrating a hydrocarbon material processing system according to a fourth embodiment of the present invention;

FIG. 8 is a block diagram illustrating a hydrocarbon material processing system according to a fifth embodiment of the present invention; and

FIG. 9 is a block diagram illustrating a hydrocarbon material processing system according to a sixth embodiment of the present invention.

### BEST MODE FOR CARRYING OUT THE INVENTION

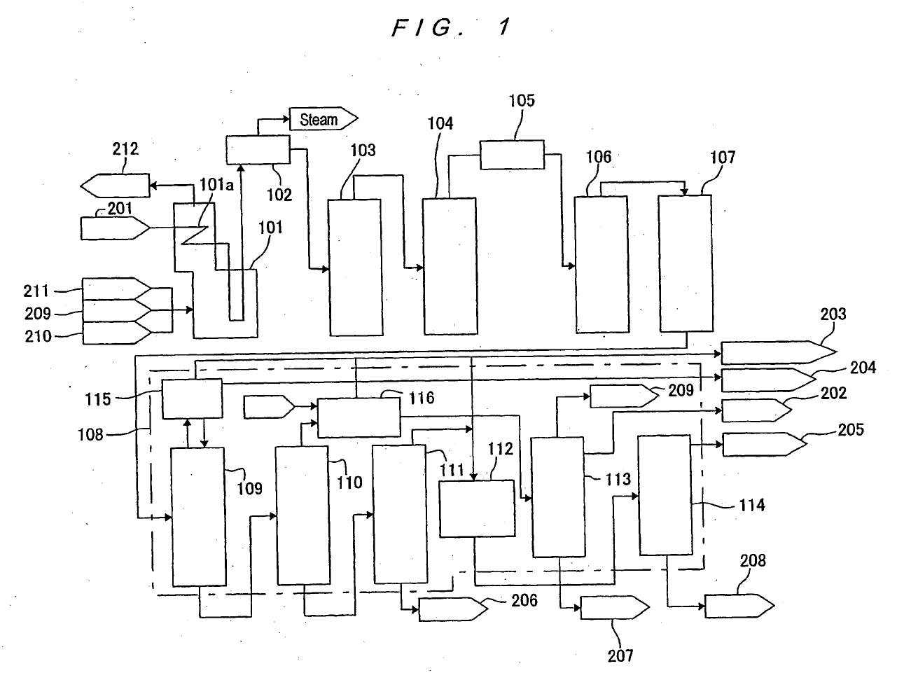

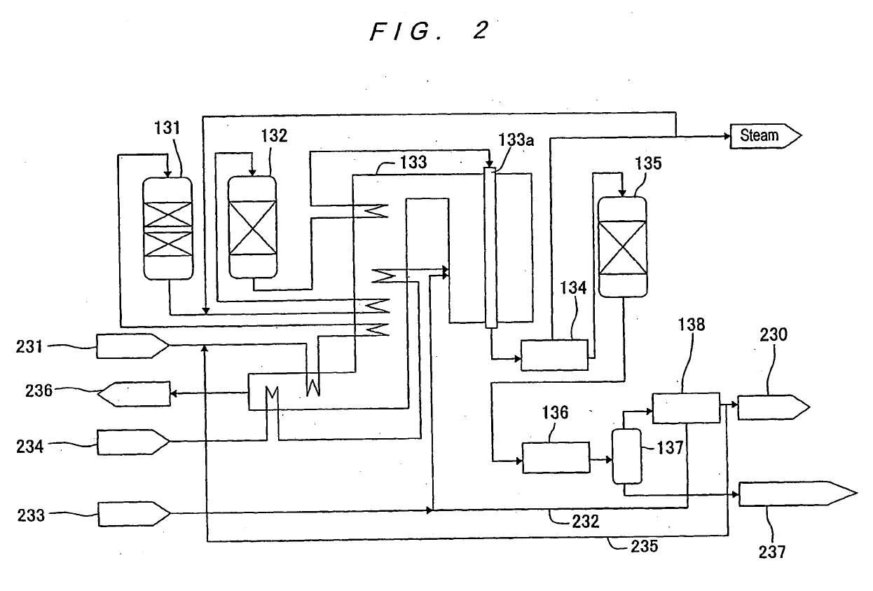

Embodiments of a hydrocarbon material processing system according to the present invention will be described below with reference to the accompanying drawings. In the following embodiments, like components are designated by the same reference numerals as those shown in FIGS. 1 and 2.

One of objects of the present invention is to provide a hydrocarbon material processing system which can continuously and stably be used in an ethylene manufacturing system even if solid materials such as wastes, waste plastics, or biomass, and residual hydrocarbon heavy oil such as pyrolysis tar containing a large amount of carbon are used as a heat source. Stable operation is achieved when stable flame is formed in a cracking furnace so as to stabilize the temperature and pressure of the cracking furnace, when a pyrolysis pipe is not worn by dust or the like, when the heat transfer speed is not lowered by accumulation of dust or the like on a surface of a pipe, or when no corrosion is caused by acid gas components such as chlorine compounds or sulfur compounds. Stable flame can be formed when a gas having constant components and a constant heating value is supplied at a constant rate.

Thus, one of the objects of the present invention is to provide an ethylene manufacturing system which can continuously supply a combustible gas having constant components and a constant heating value, which does not contain a large amount of dust or acid gas components such as chlorine compounds or sulfur compounds, at a constant rate while using solid materials such as wastes, waste plastics, or biomass, and residual hydrocarbon heavy oil such as pyrolysis tar containing a large amount of carbon as a heat source.

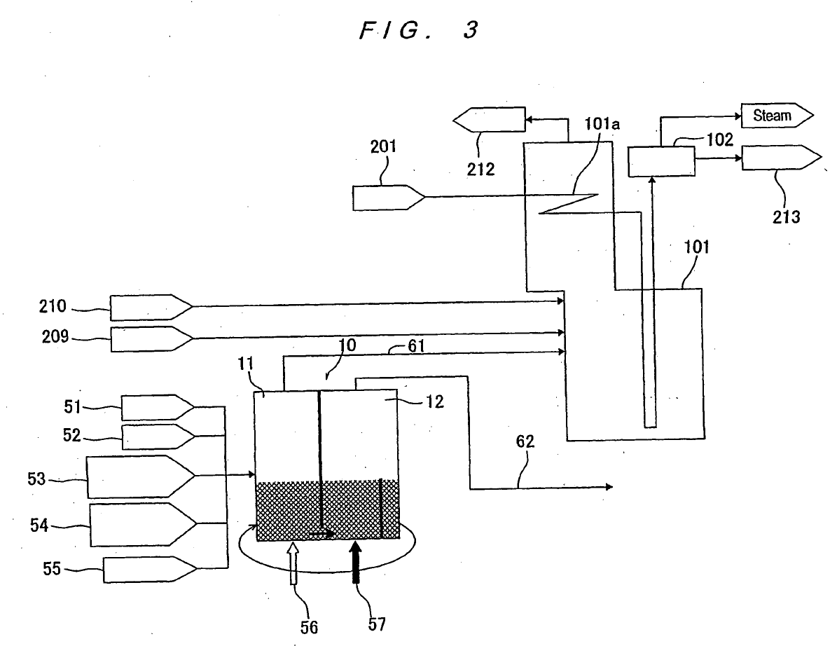

FIG. 3 is a block diagram illustrating a hydrocarbon material processing system according to a first embodiment of the present invention. As shown in FIG. 3, the hydrocarbon material processing system has a gasification furnace 10 including a gasification chamber 11 and a combustion chamber 12. Gases 61 and 62 are separately discharged from the gasification chamber 11 and the combustion chamber 12, respectively. The gasification furnace 10 is incorporated into an ethylene manufacturing system as shown in FIG. 1 so as to form a hydrocarbon material processing system.

The gasification chamber 11 of the gasification furnace 10 is supplied with one of wastes 51, waste plastics 52, pyrolysis tar 53, residual hydrocarbon heavy oil 54, and organic matter such as biomass 55, or a combination of these materials. The supplied material is pyrolyzed and gasified in the gasification chamber 11 to produce a gas 61 containing combustible gas. The produced gas 61 is supplied as a heat source to the cracking furnace 101 of the ethylene manufacturing system. Specifically, the produced gas 61 obtained by pyrolysis and gasification of wastes, residual hydrocarbon heavy oil, and organic matter in the gasification furnace 10 is supplied into the cracking furnace 101 of the ethylene manufacturing system instead of fossil fuel such as naphtha.

The cracking furnace 101 is designed so as to combust a gas therein. Accordingly, it is difficult to supply solid materials, such as wastes 51, waste plastics 52, or biomass 55, as a heat source directly to the cracking furnace 101. Even if solid materials can be supplied directly to the cracking furnace 101, it takes much time to combust solid carbon components other than volatile components in the solid materials. Thus, it is difficult to achieve stable combustion and stable heat recovery. Further, if residual hydrocarbon heavy oil such as pyrolysis tar 53, which contains a large amount of carbon, is supplied directly to the cracking furnace 101, solid carbon components, which have not been volatilized, remains in the cracking furnace 101. Thus, it takes much time to combust the solid carbon components, so that it is difficult to achieve stable combustion and stable heat recovery. In order to solve these drawbacks, in the present embodiment, the materials are previously pyrolyzed and gasified in the gasification chamber 11 of the gasification furnace 10, and then the produced gas 61 is utilized as a heat source for the cracking furnace 101.

In the present embodiment, since the gasification furnace 10 includes the gasification chamber 11 and the combustion chamber 12, pyrolysis and gasification can be performed while controlling conditions such as the temperature of the gasification chamber 11 even in a case of solid materials such as wastes, waste plastics, or biomass. Accordingly, the produced 61 gas can have constant components and a constant heating value and can be supplied to the cracking furnace 101 instead of fossil fuel. In particular, in a case of a fluidized-bed gasification furnace, even if the amount of supplied raw material is varied, the variation can be absorbed by controlling the height of the fluidized bed. Thus, it is possible to prevent pressure variation of the produced gas due to variation of the amount of supplied raw material. Further, ash is produced by combustion of a residue, which is produced by pyrolysis and gasification of the raw material used as a heat source. Accordingly, in the present embodiment, since the gasification chamber 11 and the combustion chamber 12 are separated from each other so as to separately generate the produced gas 61 and the combustion gas 62 of the residue, the produced gas 61 hardly contains ash. Furthermore, in the case of a fluidized-bed furnace, the superficial velocity in a gasification chamber is lower than that in a combustion chamber, so that the amount of bed material mixed into the produced gas in the gasification chamber becomes smaller than that in the combustion chamber. Accordingly, it is possible to supply the produced gas 61, which contains a small amount of dust, to the cracking furnace 101.. Further, by mixing a dechlorination agent or a desulfurization agent for capturing chlorine or sulfur, e.g. limestone, into the gasification furnace 10, the produced gas 61 can be supplied to the cracking furnace 101 in a state such that the produced gas 61 hardly contains chlorine compounds or sulfur compounds.

In the present embodiment, the produced gas 61 containing combustible gas, which is produced in the gasification chamber 11 of the gasification furnace 10, is supplied to the cracking furnace 101 and combusted together with off-gas 209 and combustion air 210 in the ethylene manufacturing system. The off-gas 209 and combustion air 210 are supplied to the cracking furnace 101 separately from the produced gas 61. Thus, heat required for pyrolysis of the hydrocarbon material such as naphtha is supplied to the reaction pipes 101a of the cracking furnace 101.

Pyrolysis gas 213, which has been discharged from the reaction pipes 101a of the cracking furnace 101 and quickly cooled in the heat exchanger 102, is supplied through the oil quenching tower 103, the water quenching tower 104, the compressor 105, the acid gas removal unit 106, and the dehydrating tower 107 to the gas separation and refining unit 108 (see FIG. 1). Processes performed downstream of the heat exchanger 102 are the same as described in connection with FIG. 1 and will not be described repetitively.

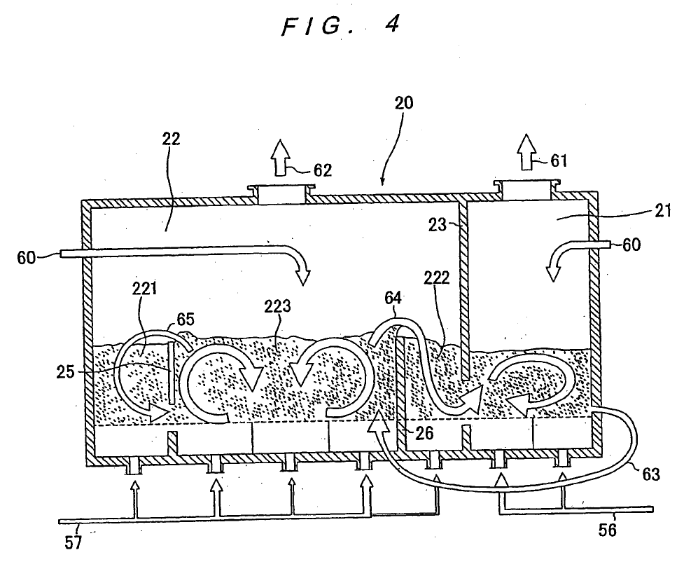

FIG. 4 shows an example of an internal circulating fluidized-bed gasification furnace 20 which can be used as the gasification furnace 10. As shown in FIG. 4, the internal circulating fluidized-bed gasification furnace 20 has a gasification chamber 21, a combustion chamber 22, and a partition wall 23 provided between the gasification chamber 21 and the combustion chamber 22. The combustion chamber 22 has partition walls 25 and 26 provided therein so as to form a heat recovery chamber 221, a bed material settling chamber 222, and a primary combustion chamber 223. The gasification chamber 21 and the combustion chamber 22 hold a bed material (fine particles such as sands) filled at lower portions of the gasification chamber 21 and the combustion chamber 22. As shown in FIG. 4, air 57 is supplied as a fluidizing gas for fluidizing the bed material from the bottom of the combustion chamber 22, and steam 56 is supplied as a fluidizing gas for fluidizing the bed material from the bottom of the gasification chamber 21.

In the internal circulating fluidized-bed gasification furnace 20, the bed material in the gasification chamber 21 is introduced into the primary combustion chamber 223 of the combustion chamber 22 through a bed material circulation passage (not shown) as shown by an arrow 63. The bed material is increased in temperature by combustion of carbon components in the primary combustion chamber 223. The high-temperature bed material overflows the partition wall 26 into the bed material settling chamber 222 as shown by an arrow 64. The bed material in the bed material settling chamber 222 is then introduced into the gasification chamber 21 through an opening defined below the partition wall 23. Specifically, the bed material is circulated between the gasification chamber 21 and the combustion chamber 22.

Further, the bed material in the primary combustion chamber 223 of the combustion chamber 22 overflows the partition wall 25 into the heat recovery chamber 221 as shown by an arrow 65. The bed material in the heat recovery chamber 221 is then introduced into the primary combustion chamber 223 through an opening defined below the partition wall 25. Specifically, the bed material is circulated between the primary combustion chamber 223 and the heat recovery chamber 221.

In the internal circulating fluidized-bed gasification furnace 20, combustibles 60 are supplied into the gasification chamber 21 at a constant rate. The combustibles 60 include one of wastes 51, waste plastics 52, pyrolysis tar 53, residual hydrocarbon heavy oil 54, and biomass 55, or a combination of these materials (see FIG. 3). Accordingly, volatile components of the combustibles 60 are pyrolyzed (or thermally cracked) into pyrolysates. The pyrolysis of the combustibles 60 produces a residue containing a large amount of carbon in the gasification chamber 21. The residue is moved together with the bed material to the combustion chamber 22 as shown by the affow 63. The carbon components of the combustibles 60 are combusted in the combustion chamber 22. Heat of the combustion increases the temperature of the bed material. Then, the high-temperature bed material is introduced into the gasification chamber 21 as shown by the arrow 64 so as to contribute to pyrolysis (or thermal cracking) of the combustibles 60 supplied into the gasification chamber 21.

When the combustibles 60 to be pyrolyzed (or thermally cracked) contain more volatile components and less solid carbon, less carbon components are introduced into the combustion chamber 22 together with the bed material as shown by the arrow 63. Accordingly, the amount of combustion in the combustion chamber 22 is reduced so that the amount of heat required for the gasification chamber 21 is not maintained. In such a case, combustibles 60 may also be supplied to the combustion chamber 22 so as to compensate for the amount of combustion in the combustion chamber 22.

As described above, the combustibles 60, which include one of wastes 51, waste plastics 52, pyrolysis tar 53, residual hydrocarbon heavy oil 54, and biomass 55, or a combination of these materials, are introduced into the gasification chamber 21 of the internal circulating fluidized-bed gasification furnace 20 and pyrolyzed (or thermally cracked) therein. The carbon components that have not been pyrolyzed (or thermally cracked) are introduced into the combustion chamber 22 together with the bed material so as to selectively combust the carbon components.

In the internal circulating fluidized-bed gasification furnace 20 shown in FIG. 4, the temperatures of the fluidized beds of the gasification chamber 21 and the combustion chamber 22 can be controlled by varying the amount of circulated bed material. Accordingly, by adjusting the amount of circulated bed material according to the amount of raw material supplied to the gasification chamber so that the produced gas has constant components and a constant heating value, the temperatures of the fluidized beds of the gasification chamber 21 and the combustion chamber 22 can be adjusted so as to control components of the produced gas.

Thus, the combustibles 60, which include one of wastes 51, waste plastics 52, pyrolysis tar 53, residual hydrocarbon heavy oil 54, and biomass 55, or a combination of these materials, are introduced into the gasification chamber 21 of the internal circulating fluidized-bed gasification furnace 20 and pyrolyzed (or thermally cracked) therein. Resultant produced gas 61 is supplied as a heat source to the cracking furnace 101 in the ethylene manufacturing system. Thus, the produced gas 61 can be substituted for fossil fuel, which has been used in a conventional ethylene manufacturing system. Accordingly, it is possible to reduce cost for producing ethylene and also reduce the amount of carbon dioxide discharged from the system.

In a case where the produced gas 61 contains a large amount of dust, the produced gas 61 may be cleaned to prevent troubles such as clogging of a produced gas duct due to condensation or deposition. When a distance between the gasification furnace 10 and the cracking furnace 101 is so long that macromolecular hydrocarbon or steam may be condensed by temperature drop due to radiation from the produced gas duct, the produced gas 61 may be cleaned for the same reason. In these cases, an oil scrubber is preferably used to clean the produced gas 61.

A fluidized-bed gasification furnace is advantageous in resistance to incombustibles (solid materials) as compared to an entrained-bed gasification furnace since the fluidized-bed gasification furnace has a fluidized bed. Further, even if the calorie or amount of combustibles to be introduced has variations, a fluidized-bed gasification furnace can perform processes more stably than an entrained-bed gasification furnace. In particular, when an internal circulating fluidized-bed gasification furnace 20 as shown in FIG. 4 is used, incombustibles can be withdrawn from a furnace bottom of the gasification chamber 21 to recover valuable metals without oxidation. Thus, an internal circulating fluidized-bed gasification furnace is more effective than a partial combustion fluidized-bed gasification furnace. Furthermore, incombustibles can be withdrawn from a furnace bottom of the combustion chamber 22 to recover clean incombustibles.

In a case of the internal circulating fluidized-bed gasification furnace 20, the bed material may include limestone so that limestone is circulated between the gasification chamber 21 and the combustion chamber 22. In the gasification chamber 21, calcium oxide (CaO) absorbs CO₂ so as to be converted into calcium carbonate (CaCO₃). In the combustion chamber 22, CaCO₃ is pyrolyzed into CaO, which is moved together with the bed material to the gasification chamber 21 and used for absorption of CO₂. Thus, combustible gas having a considerably small amount of CO₂ can be obtained as the produced gas 61. Specifically, combustible gas having a higher heating value can be recovered as the produced gas 61.

In a case where catalysts or absorbent particles are used in the furnace, particles can be circulated between the gasification chamber 21 (under a reducing atmosphere) and the combustion chamber 22 (under an oxidation atmosphere) in the internal circulating fluidized-bed gasification furnace 20. Since the particles are repeatedly subjected to oxidation and reduction, the particles of catalysts or absorbents are regenerated and activated in the combustion chamber 22 so as to effectively serve in gasification chamber 21. For example, when the bed material includes calcium carbonate (CaCO₃) particles for desulfurization, CaCO₃ particles are pyrolyzed into CaO in the combustion chamber 22. In the gasification chamber 21, CaO particles absorb chlorine components so as to be converted into CaCl₂. Then, CaCl₂ is pyrolyzed into CaO in the combustion chamber 22.

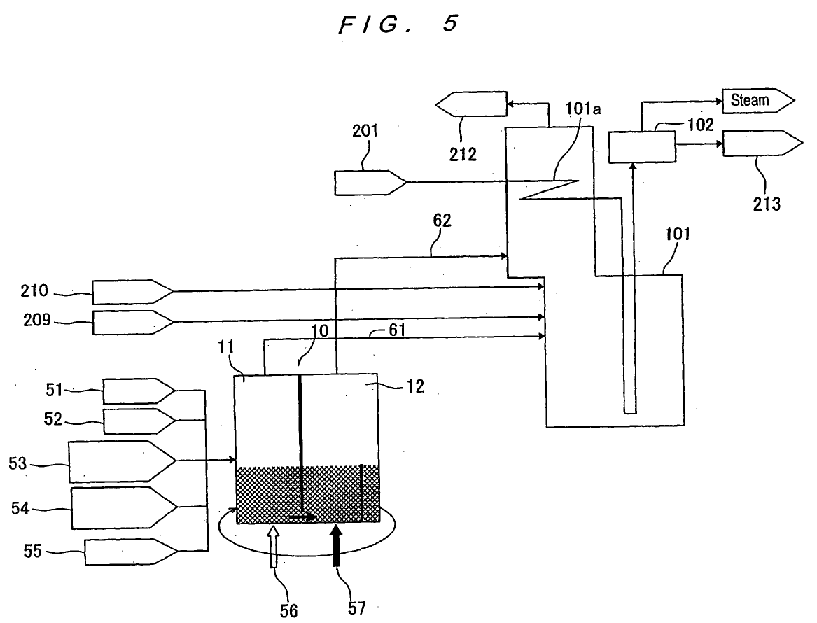

FIG. 5 is a block diagram illustrating a hydrocarbon material processing system according to a second embodiment of the present invention. As shown in FIG. 5, the hydrocarbon material processing system has a gasification furnace 10 including a gasification chamber 11 and a combustion chamber 12. Gases 61 and 62 are separately discharged from the gasification chamber 11 and the combustion chamber 12, respectively. The gasification furnace 10 is incorporated into an ethylene manufacturing system as shown in FIG. 1 so as to form a hydrocarbon material processing system.

The gasification chamber 11 of the gasification furnace 10 is supplied with one of wastes 51, waste plastics 52, pyrolysis tar 53, residual hydrocarbon heavy oil 54, and organic matter such as biomass 55, or a combination of these materials. The supplied material is pyrolyzed and gasified in the gasification chamber 11 to produce a gas 61 containing combustible gas. The produced gas 61 is supplied as a heat source to the cracking furnace 101 of the ethylene manufacturing system. Further, a pyrolysis residue produced by pyrolysis and gasification in the gasification chamber 11 is combusted in the combustion chamber 12 to produce a combustion gas 62. The combustion gas 62 is also supplied as a heat source to the cracking furnace 101 of the ethylene manufacturing system.

With this configuration, since the combustion gas 62 from the combustion chamber 12 contains oxygen, the amount of combustion air 210 to be supplied to the cracking furnace 101 can be reduced. Further, when the sensible heat of the combustion gas 62, which has a high temperature of about 800 to 1000° C., is supplied to the cracking furnace 101, the heat of the combustibles supplied to the gasification furnace 10 can effectively be employed in the cracking furnace 101.

Pyrolysis gas 213, which has been discharged from the reaction pipes 101a of the cracking furnace 101 and quickly cooled in the heat exchanger 102, is supplied through the oil quenching tower 103, the water quenching tower 104, the compressor 105, the acid gas removal unit 106, and the dehydrating tower 107 to the gas separation and refining unit 108 (see FIG. 1). Processes performed downstream of the heat exchanger 102 are the same as described in connection with FIG. 1 and will not be described repetitively.

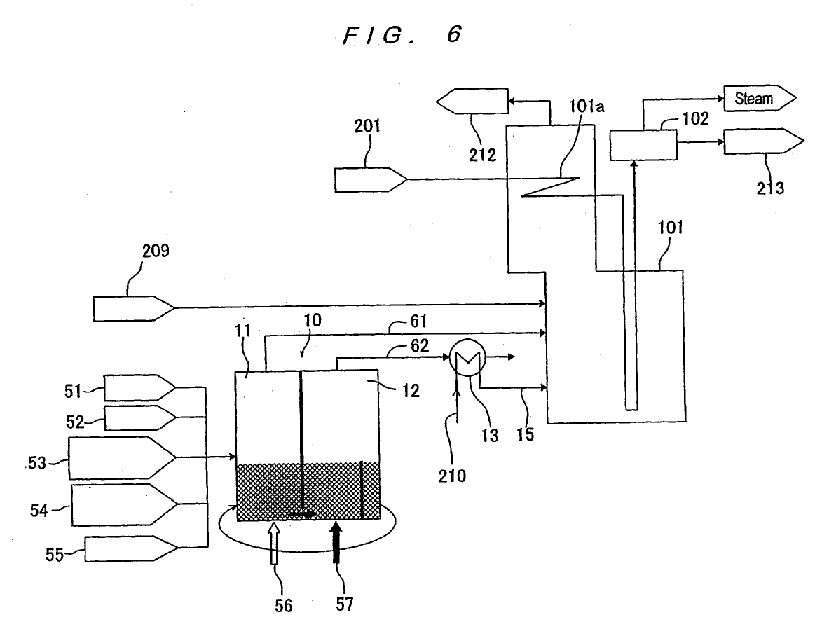

FIG. 6 is a block diagram illustrating a hydrocarbon material processing system according to a third embodiment of the present invention. As shown in FIG. 6, the hydrocarbon material processing system has a gasification furnace 10 including a gasification chamber 11 and a combustion chamber 12. Gases 61 and 62 are separately discharged from the gasification chamber 11 and the combustion chamber 12, respectively. The gasification furnace 10 is incorporated into an ethylene manufacturing system as shown in FIG. 1 so as to form a hydrocarbon material processing system.

The gasification chamber 11 of the gasification furnace 10 is supplied with one of wastes 5 1, waste plastics 52, pyrolysis tar 53, residual hydrocarbon heavy oil 54, and organic matter such as biomass 55, or a combination of these materials. The supplied material is pyrolyzed and gasified in the gasification chamber 11 to produce a gas 61 containing combustible gas. The produced gas 61 is supplied as a heat source to the cracking furnace 101 of the ethylene manufacturing system. Further, a pyrolysis residue produced by pyrolysis and gasification in the gasification chamber 11 is combusted in the combustion chamber 12 to produce a combustion gas 62. The hydrocarbon material processing system has a combustion gas heat exchanger 13 provided downstream of the combustion chamber 12 of the gasification furnace 10, and a passage 15 for supplying combustion air 210 to the cracking furnace 101. Thus, the combustion gas 62 is supplied to the combustion gas heat exchanger 13 for preheating the combustion air 210 to be supplied to the cracking furnace 101 by using the sensible heat of the combustion gas 62.

With this configuration, the sensible heat of the combustion gas 62, which has a high temperature of about 800 to 1000° C., can be supplied to the cracking furnace 101. Thus, the heat of the combustibles supplied to the gasification furnace 10 can effectively be employed in the cracking furnace 101.

In FIG. 6, only the combustion gas heat exchanger 13 is employed to preheat the combustion air 210. However, two or more heat exchangers may be employed to preheat the combustion air 210. For example, the air 210 may be preheated by the heat exchanger 102 disposed downstream of the cracking furnace 101 and the combustion gas heat exchanger 13.

Pyrolysis gas 213, which has been discharged from the reaction pipes 101a of the cracking furnace 101 and quickly cooled in the heat exchanger 102, is supplied through the oil quenching tower 103, the water quenching tower 104, the compressor 105, the acid gas removal unit 106, and the dehydrating tower 107 to the gas separation and refining unit 108 (see FIG. 1). Processes performed downstream of the heat exchanger 102 are the same as described in connection with FIG. 1 and will not be described repetitively.

In each of the first, second, and third embodiments, the hydrocarbon material processing system employs an ethylene manufacturing system having a cracking furnace. However, the cracking furnace in the hydrocarbon material processing system is not limited to a cracking furnace in an ethylene manufacturing system. The cracking furnace may comprise a cracking furnace for thermally cracking a hydrocarbon material to produce hydrocarbon other than ethylene (e.g., light gas such as LPG).

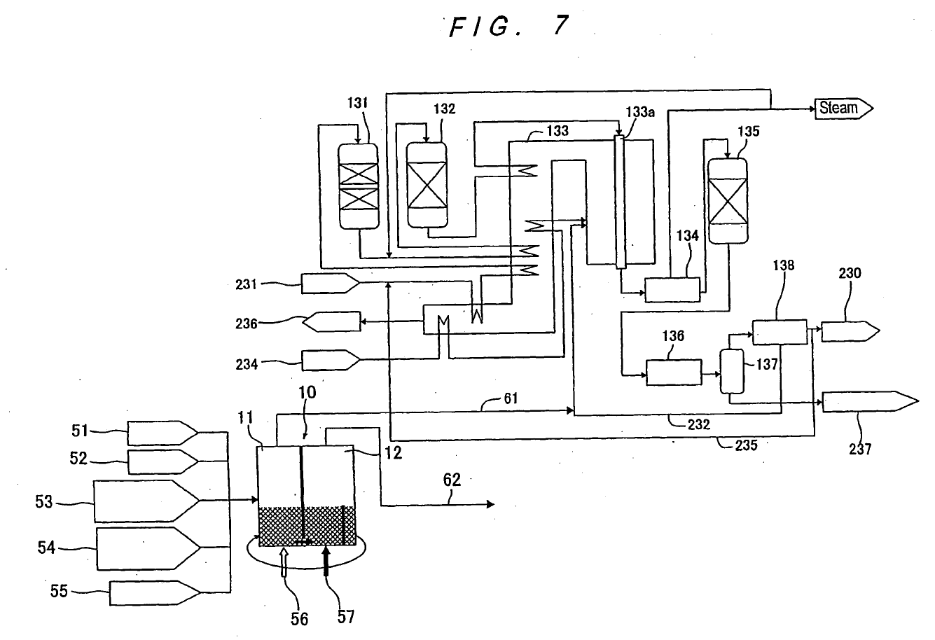

FIG. 7 is a block diagram illustrating a hydrocarbon material processing system according to a fourth embodiment of the present invention. As shown in FIG. 7, the hydrocarbon material processing system has a gasification furnace 10 including a gasification chamber 11 and a combustion chamber 12. Gases 61 and 62 are separately discharged from the gasification chamber 11 and the combustion chamber 12, respectively. The gasification furnace 10 is incorporated into a hydrogen manufacturing system as shown in FIG. 2 so as to form a hydrocarbon material processing system.

The gasification chamber 11 of the gasification furnace 10 is supplied with one of wastes 51, waste plastics 52, pyrolysis tar 53, residual hydrocarbon heavy oil 54, and organic matter such as biomass 55, or a combination of these materials. The supplied material is pyrolyzed and gasified in the gasification chamber 11 to produce a gas 61 containing combustible gas. The produced gas 61 is supplied as a heat source to the reforming furnace 133 of the hydrogen manufacturing system. Specifically, the produced gas 61 obtained by pyrolysis and gasification of wastes, residual hydrocarbon heavy oil, and organic matter in the gasification furnace 10 is supplied into the reforming furnace 133 of the hydrogen manufacturing system instead of fossil fuel such as naphtha.

In the present embodiment, the produced gas 61 containing combustible gas, which is produced in the gasification chamber 11 of the gasification furnace 10, is supplied to the reforming furnace 133 and combusted together with hydrogen PSA off-gas 232 and combustion air 234 in the hydrogen manufacturing system. The off-gas 232 and combustion air 234 are supplied to the reforming furnace 101 separately from the produced gas 61. Thus, heat required for reforming of the hydrocarbon material such as naphtha is supplied to the reaction pipes 133a of the reforming furnace 133. The gasification furnace 10 may employ a fluidized-bed gasification furnace, more specifically, an internal circulating fluidized-bed gasification furnace 20 as shown in FIG. 4. The hydrogen manufacturing process is the same as described in connection with FIG. 2 and will not be described repetitively.

Thus, the combustibles, which include one of wastes 51, waste plastics 52, pyrolysis tar 53, residual hydrocarbon heavy oil 54, and biomass 55, or a combination of these materials, are introduced into the gasification chamber 11 of the gasification furnace 10 and pyrolyzed (or thermally cracked) therein. Resultant produced gas 61 containing combustible gas is supplied as a heat source to the reforming furnace 133 in the hydrogen manufacturing system. Thus, the produced gas 61 can be substituted for fossil fuel, which has been used in a conventional hydrogen manufacturing system. Accordingly, it is possible to reduce cost for producing hydrogen and also reduce the amount of carbon dioxide discharged from the system.

In a case where the produced gas 61 contains a large amount of dust, the produced gas 61 may be cleaned to prevent troubles such as clogging of a produced gas duct due to condensation or deposition. When a distance between the gasification furnace 10 and the reforming furnace 133 is so long that macromolecular hydrocarbon or steam may be condensed by temperature drop due to radiation from the produced gas duct, the produced gas 61 may be cleaned for the same reason. In these cases, an oil scrubber is preferably used to clean the produced gas 61.

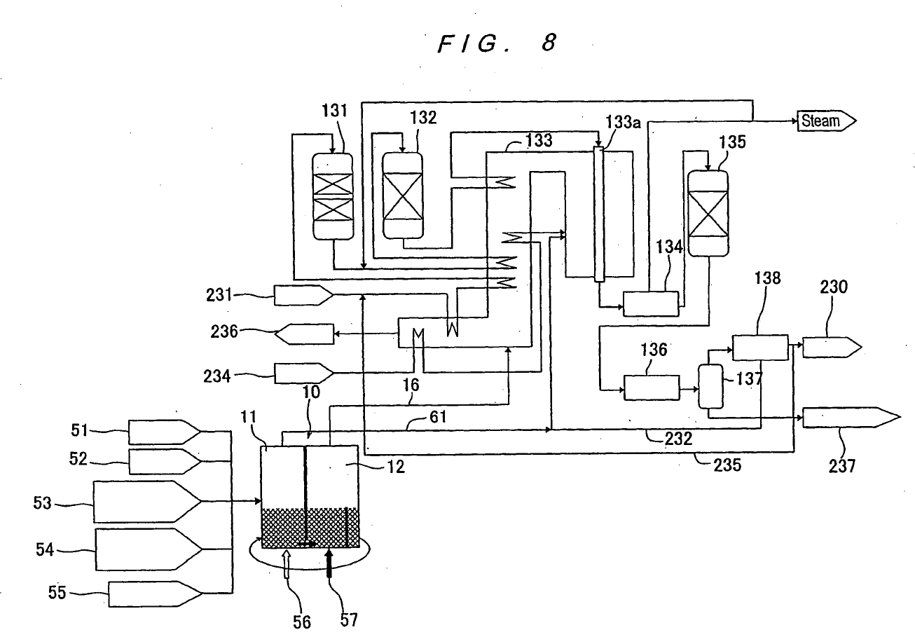

FIG. 8 is a block diagram illustrating a hydrocarbon material processing system according to a fifth embodiment of the present invention. As shown in FIG. 8, the hydrocarbon material processing system has a gasification furnace 10 including a gasification chamber 11 and a combustion chamber 12. Gases 61 and 62 are separately discharged from the gasification chamber 11 and the combustion chamber 12, respectively. The gasification furnace 10 is incorporated into a hydrogen manufacturing system as shown in FIG. 2 so as to form a hydrocarbon material processing system.

The gasification chamber 11 of the gasification furnace 10 is supplied with one of wastes 51, waste plastics 52, pyrolysis tar 53, residual hydrocarbon heavy oil 54, and organic matter such as biomass 55, or a combination of these materials. The supplied material is pyrolyzed and gasified in the gasification chamber 11 to produce a gas 61 containing combustible gas. The produced gas 61 is supplied as a heat source to the reforming furnace 133 of the hydrogen manufacturing system. Further, a pyrolysis residue produced by pyrolysis and gasification in the gasification chamber 11 is combusted in the combustion chamber 12 to produce a combustion gas 62. The combustion gas 62 is also supplied as a heat source to the reforming furnace 133 of the hydrogen manufacturing system.

With this configuration, since the combustion gas 62 from the combustion chamber 12 contains oxygen, the amount of combustion air 234 to be supplied to the reforming furnace 133 can be reduced. Further, when the sensible heat of the combustion gas 62, which has a high temperature of about 800 to 1000° C., is supplied to the reforming furnace 133, the heat of the combustibles supplied to the gasification furnace 10 can effectively be employed in the reforming furnace 133. The hydrogen manufacturing process is the same as described in connection with FIG. 2 and will not be described repetitively.

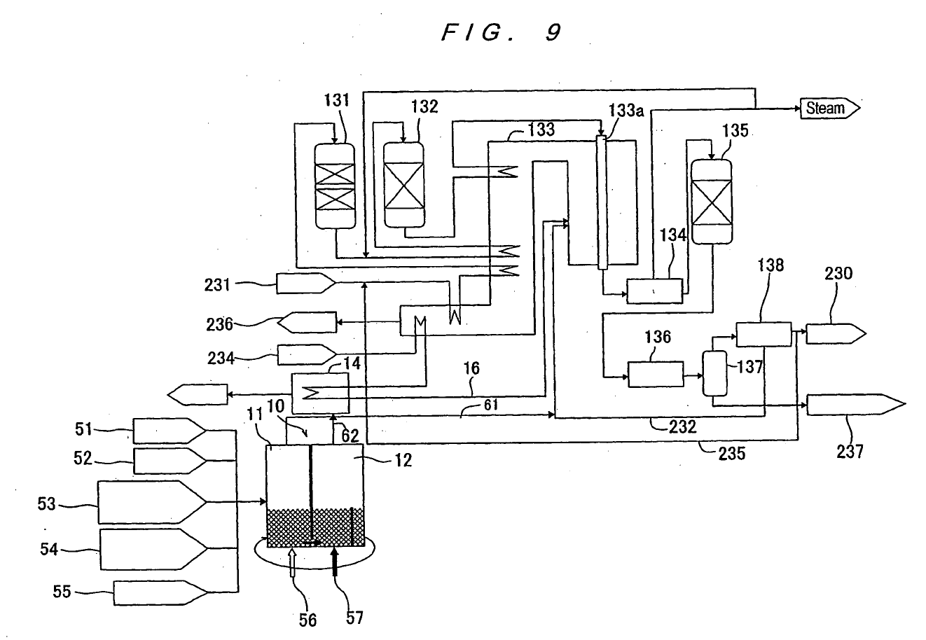

FIG. 9 is a block diagram illustrating a hydrocarbon material processing system according to a sixth embodiment of the present invention. As shown in FIG. 9, the hydrocarbon material processing system has a gasification furnace 10 including a gasification chamber 11 and a combustion chamber 12. Gases 61 and 62 are separately discharged from the gasification chamber 11 and the combustion chamber 12, respectively. The gasification furnace 10 is incorporated into a hydrogen manufacturing system as shown in FIG. 2 so as to form a hydrocarbon material processing system.

The gasification chamber 11 of the gasification furnace 10 is supplied with one of wastes 51, waste plastics 52, pyrolysis tar 53, residual hydrocarbon heavy oil 54, and organic matter such as biomass 55, or a combination of these materials. The supplied material is pyrolyzed and gasified in the gasification chamber 11 to produce a gas 61 containing combustible gas. The produced gas 61 is supplied as a heat source to the reforming furnace 133 of the hydrogen manufacturing system. Further, a pyrolysis residue produced by pyrolysis and gasification in the gasification chamber 11 is combusted in the combustion chamber 12 to produce a combustion gas 62. The hydrocarbon material processing system has a combustion gas heat exchanger 14 provided downstream of the combustion chamber 12 of the gasification furnace 10, and a passage 16 for supplying combustion air 234 to the reforming furnace 133. Thus, the combustion gas 62 is supplied to the combustion gas heat exchanger 14 for preheating the combustion air 234 to be supplied to the reforming furnace 133 by using the sensible heat of the combustion gas 62.

With this configuration, the sensible heat of the combustion gas 62, which has a high temperature of about 800 to 1000° C., can be supplied to the reforming furnace 133. Thus, the heat of the combustibles supplied to the gasification furnace 10 can effectively be employed in the reforming furnace 133.

In FIG. 9, only the combustion gas heat exchanger 14 is employed to preheat the combustion air 234. However, two or more heat exchangers may be employed to preheat the combustion air 234. For example, the air 234 may be preheated by the heat exchanger 134 disposed downstream of the reforming furnace 133, the combustion gas heat exchanger 14, and a heat exchanger disposed at an intermediate portion of the reforming furnace 133. The hydrogen manufacturing process is the same as described in connection with FIG. 2 and will not be described repetitively.

In each of the fourth, fifth, and sixth embodiments, the hydrocarbon material processing system employs a hydrogen manufacturing system having a reforming furnace. However, the reforming furnace in the hydrocarbon material processing system is not limited to a reforming furnace in a hydrogen manufacturing system. The reforming furnace may comprise a reforming furnace for reforming other hydrocarbon. For example, hydrocarbon may be supplied together with a reforming agent, such as steam, hydrogen, or hydrocarbon, into a reforming furnace so as to perform a catalytic reforming process to produce gasoline.

Although certain preferred embodiments of the present invention have been shown and described in detail, it should be understood that various changes and modifications may be made therein without departing from the scope of the appended claims.

### Industrial Applicability

The present invention is applicable to a hydrocarbon material processing system used in an oil refinery process or a petrochemical process for thermally cracking a hydrocarbon material in a cracking furnace or for reforming a hydrocarbon material in a reforming furnace.

1. A hydrocarbon material processing system comprising:
a gasification furnace for pyrolyzing and gasifying at least one of wastes, residual hydrocarbon heavy oil, and organic matter to produce a heat source gas; and
a cracking furnace for thermally cracking a hydrocarbon material by using the heat source gas produced in said gasification furnace.

2. The hydrocarbon material processing system as recited in claim 1, wherein said cracking furnace comprises a cracking furnace for an ethylene manufacturing process.

3. The hydrocarbon material processing system as recited in claim 1, wherein said gasification furnace is configured to separately produce a first gas by pyrolysis and gasification of the at least one of wastes, residual hydrocarbon heavy oil, and organic matter and a second gas by combustion of a residue of the pyrolysis and gasification.

4. The hydrocarbon material processing system as recited in claim 3, wherein the second gas is used as the heat source gas for said cracking furnace.

5. The hydrocarbon material processing system as recited in claim 3, further comprising:
a heat exchanger for preheating air by the second gas; and
a passage for supplying the preheated air to said cracking furnace.

6. A hydrocarbon material processing system comprising:
a gasification furnace for pyrolyzing and gasifying at least one of wastes, residual hydrocarbon heavy oil, and organic matter to produce a heat source gas; and
a reforming furnace for reforming a hydrocarbon material by using the heat source gas produced in said gasification furnace.

7. The hydrocarbon material processing system as recited in claim 6, wherein said reforming furnace comprises a reforming furnace for a hydrogen manufacturing process.

8. The hydrocarbon material processing system as recited in claim 6, wherein said gasification furnace is configured to separately produce a first gas by pyrolysis and gasification of the at least one of wastes, residual hydrocarbon heavy oil, and organic matter and a second gas by combustion of a residue of the pyrolysis and gasification.

9. The hydrocarbon material processing system as recited in claim 8, wherein the second gas is used as the heat source gas for said reforming furnace.

10. The hydrocarbon material processing system as recited in claim 8, further comprising:
a heat exchanger for preheating air by the second gas; and
a passage for supplying the preheated air to said reforming furnace.

11. A hydrocarbon material processing method comprising:
pyrolyzing and gasifying at least one of wastes, residual hydrocarbon heavy oil, and organic matter to produce a heat source gas; and
supplying the heat source gas to a cracking furnace for thermally cracking a hydrocarbon material.

12. The hydrocarbon material processing method as recited in claim 11, wherein said cracking furnace comprises a cracking furnace for an ethylene manufacturing process.

13. The hydrocarbon material processing method as recited in claim 11, wherein said pyrolyzing and gasifying comprises separately producing a first gas by pyrolysis and gasification of the at least one of wastes, residual hydrocarbon heavy oil, and organic matter and a second gas by combustion of a residue of the pyrolysis and gasification.

14. The hydrocarbon material processing method as recited in claim 13, wherein the second gas is used as the heat source gas for said cracking furnace.

15. The hydrocarbon material processing method as recited in claim 13, further comprising:
preheating air by heat exchange with the second gas; and
supplying the preheated air to said cracking furnace.

16. A hydrocarbon material processing method comprising:
pyrolyzing and gasifying at least one of wastes, residual hydrocarbon heavy oil, and organic matter to produce a heat source gas; and
supplying the heat source gas to a reforming furnace for reforming a hydrocarbon material.

17. The hydrocarbon material processing method as recited in claim 16, wherein said reforming furnace comprises a reforming furnace for a hydrogen manufacturing process.

18. The hydrocarbon material processing method as recited in claim 16, wherein said pyrolyzing and gasifying comprises separately producing a first gas by pyrolysis and gasification of the at least one of wastes, residual hydrocarbon heavy oil, and organic matter and a second gas by combustion of a residue of the pyrolysis and gasification.

19. The hydrocarbon material processing method as recited in claim 18, wherein the second gas is used as the heat source gas for said reforming furnace.

20. The hydrocarbon material processing method as recited in claim 18, further comprising:
preheating air by heat exchange with the second gas; and
supplying the preheated air to said reforming furnace.
